(19) United States
(12) Patent Application Publication
(10) Pub. No.: US 2006/0288797 A1
(43) Pub. Date: Dec. 28, 2006

(54) Method for measuring physical parameters of at least one micrometric or nanometric dimensional phase in a composite system

(76) Inventors: Jean-Luc Rouviere, Meylan (FR); Laurent Clement, Grenoble (FR); Roland Pantel, Poisat (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/565,034

(22) PCT Filed: Jul. 16, 2004
(86) PCT No.: PCT/FR04/01877

§ 371 Date: Jun. 8, 2006

(30) Foreign Application Priority Data
Jul. 18, 2003 (FR) 0308782

(51) Int. Cl. G01N 19/00

(52) U.S. Cl. 73/804

(57) ABSTRACT

The invention relates to a method for determining at least one mechanical parameter of at least one material in a composite system comprising at least two distinct phases, characterized in that it comprises: a) the production of at least one specimen comprising a first part of a first phase and a second part of a second phase, the second part consisting of the material to be characterized, the specimen having at least one dimension small enough to allow the strains in said specimen to be relaxed; b) the measurement, on said specimen, of at least one deformation parameter of at least said first phase, in correspondence with a plurality of points lying at different distances from an interface between said first and second phases; and c) the determination, from at least said deformation parameter, of at least one mechanical parameter of said second phase.

The subject of the present invention is a method of determining at least one mechanical parameter of at least one material in a composition system comprising at least two distinct phases. The method applies more particularly to the case in which the phase to be characterized is of a microscale or nanoscale structure, and at least one other material constitutes a substrate or a matrix. For example, the method applies to the characterization of a thin film deposited on a substrate or of inclusions, filaments or fibers in a matrix.

The expression “mechanical parameters” is used here to indicate both mechanical and thermomechanical properties, such as the Young's modulus, the Poisson's ratio, the thermal expansion coefficient, etc., and strain and/or stress states.

Knowing the mechanical properties of a system or physical device allows its operation to be optimized. Any material, whatever it is, is subjected to external stresses and is necessary to be able to determine its resistance to such stresses. It is therefore important to completely determine the elastic properties of a system and in particular those of one or more layers placed on the surface of a substrate. This is because the properties of this layer (or these layers considered as a subsystem) differ appreciably from the properties of the films taken individually.

The elastic properties of materials are involved in many fields of application: coating of mechanical parts, structural deformation, etc. They play an increasingly important role in the fabrication of electronic circuits: since the size of devices is decreasing, the strains generated at the interface of the various parts of the device are correspondingly higher.

The methods already developed for measuring the elastic constants and expansion coefficients are generally carried out on a macroscale.

The conventional methods are:
A) deflection or deformation of macroscopic or smaller specimens, see for example: “Measurement of elastic modulus, Poisson ratio and coefficient of thermal expansion of on-wafer submicron films” by Jie-Hua Zhao, Todd Ryan, Paul S. Ho, Andrew J. McKerrow and Wei-Yan Shih, PRC/MER2.206, Journal of Applied Physics (1999), 85/(9), 6421-6424; or “Elastic modulus measurements by three methods on a 2-D laminated continuous fiber-reinforced ceramic matrix composite” by S. T. Gonczy and M. G. Jenkins, Ceramic Transactions (2000), 103 (Advances in Ceramic-Matrix Composites V), 541-547; or else “Analysis of residual stress in cubic boron nitride thin films using micromachined cantilever beams” by G. F. Cardinale, D. G. Howitt, K. F. McCarty, D. L. Medlin, P. B. Mirkarimi and N. R. Moody, Diamond and Related Materials (1996), 5(11), 1295-1302;
B) electroacoustic waves: for example, “Hardness and Young's modulus of high-quality cubic boron nitride films grown by chemical vapor deposition” by X. Jiang, J. Philip, W. J. Zhang, P. Hess and S. Matsumoto, Journal of Applied Physics (2003), 93(3), 1515-1519 or “Thin-film elastic-property measurements with laser-ultrasonic SAW spectrometry” by D. C. Hurley, V. K. Tewary and A. J. Richards, Thin Solid Films (2001), 398-399), 326-330; and
C) nanoindentation: for example, “Determination of mechanical film properties of a bilayer system due to elastic indentation measurements with a spherical indenter” by T. Chudoba, N. Schwarzer, F. Richter and U. Beck in Thin Solid Films (2000), 377-378, 366-372 or “Hardness and elastic modulus measurements of AlN and TiN sub-micron thin films using the continuous stiffness measurement technique with FEM analysis” by T. A. Rawdanowicz, J. Sankar, J. Narayan and V. Godbole, Materials Research Society Symposium Proceedings (2000), 594 (Thin Films—Stresses and Mechanical Properties VIII), 507-512.

There are also more recent methods for measuring the mechanical properties of small objects, for example atomic force microscopy (AFM) described for example in “Measurements of elastic properties of ultra-thin diamond-like carbon coatings using atomic force acoustic microscopy” by S. Amelio, A. V. Goldade, U. Rabe, V. Scherer, B. Bhushan and W. Arnold, Thin Solid Films (2001), 392(1), 75-84.

The object of the invention is to measure one or more mechanical parameters, especially the elastic constants and the thermal expansion coefficients of a material and the strains that this material generates when it is combined with other materials. Its specificity is to be able to measure such parameters under conditions close to their application conditions: thin or thick films, inhomogeneous layers, discontinuous “layers” or precipitates/inclusions, fibers or filaments, and boxes (the term more specific to semiconductor materials in which charges are localized in these boxes formed from a second material different from the substrate). Current knowledge prevents one from asserting that microscopically measured parameters can be used in structures of small dimensions, that is to say on a microscale or nanoscale.

The basic idea of the invention consists in using a phenomenon that is well known but is generally considered as a drawback, which it is sought to avoid or neglect: in a specimen having at least one sufficiently small dimension, for example on the micron or submicron scale, owing to the proximity of the free surface, the strains built up in the initial device are relaxed (see the aforementioned documents by D. Perovic, G. Weatherly and D. Houghton, Phil. Mag. 64, (1991)). According to the invention, it is unnecessary to make direct measurements on the material to be characterized (something that is not always possible or easy): by measuring the deformation parameters of the substrate or matrix, the origin of which is the relaxation of the strains in the specimen, it is possible to obtain the parameters of the phase with the microscale or nanoscale structure. Any measurements made on this phase, when they are technically possible, provide additional information but they are not in general essential.

The expression “deformation parameter” is understood to mean both pure deformations, usually indicated by the symbol ε and which, from the microscopic standpoint, correspond to changes in the crystal parameters, and local rotations of crystal axes, indicated by the symbol β.

The invention therefore relates to a method for determining at least one mechanical parameter of at least one material in a composite system comprising at least two distinct phases, characterized in that it comprises:
a) the production of at least one specimen comprising a first part of a first phase and a second part of a second phase, the second part consisting of the material to be characterized, the specimen having at least one dimension small enough to allow the strains in said specimen to be relaxed;
b) the measurement, on said specimen, of at least one deformation parameter of at least said first phase, in correspondence with a plurality of points lying at different distances from an interface between said first and second phases; and
c) the determination, from at least said deformation parameter, of at least one mechanical parameter of said second phase.

According to particular embodiments:
said method comprises:
   i) the production of a plurality of specimens that differ from one another in respect of at least one geometrical property;
   ii) the implementation of step b) on each of said specimens; and
   iii) the use in step c) of the measurements made on said plurality of specimens;
step b is repeated at at least two different temperatures for at least one of said specimens;
step c) comprises:
   i) the modeling of the strain relaxation in said specimen (L) using a first estimate of at least one mechanical property of the material of said second phase (B);
   ii) the comparison of the measurement results of step b) with those of said modeling; and
   iii) the modification of said estimate of at least one mechanical property of the material of said second phase and the reiteration of substeps i) to iii) until the difference between said measurement results and the modeling results is minimized.

Within this context, the term “modeling” covers both numerical simulations and approximate analytical models. Advantageously, a finite-element numerical simulation may be used;
said composite system is chosen from among: a substrate having a continuous layer on its surface; a substrate having metallization bands or islands on its surface; a layer with a zone included in the substrate; a transistor; a layer on the inside of a substrate; a matrix containing inclusions; fibers or filaments;
said specimen has at least one microscale or nanoscale dimension;
said specimen is a lamella having two approximately parallel faces lying approximately perpendicular to the interface between said first and second phases, in which case step b) is advantageously repeated for a plurality of lamella(e) of different thicknesses;
according to one alternative embodiment, said specimen is a lamella placed at an angle to the interface between said first and second phases, in which case step b) is advantageously repeated for a plurality of lamella(e) lying at different angles to the interface between said first and second phases;
according to another alternative embodiment, said specimen is a wedge-shaped lamella having two faces making an angle between them, in which case step b) is advantageously repeated for a plurality of lamella(e) having two faces making different angles between them;
the measurements provided in step b) are carried out by diffraction of a convergent electron beam;
step b) includes the observation of Holz lines for at least one crystallographic plane of said first phase and the determination of at least one parameter from among: the width of said Holz lines, their position and their internal structure;
step b) comprises the determination of at least the width of at least some of said Holz lines and the calculation, for each of them, of a maximum rotation βₘₐₓ along the axis of the electron beam; and
step c) involves the plotting of at least one curve representing a said maximum rotation as a function of the distance relative to the interface between said first and second phases.

According to a preferred embodiment, step c) also involves, by simulation, the plotting of curves representing the maximum rotation βₘₐₓ as a function of the distance relative to the interface between said first and second phases for possible values of Young's modulus and/or Poisson's ratio of the material of said second phase, and also the minimization of the difference between the simulated curves and the experimental curves in order to determine the Young's modulus and/or the Poisson's ratio of the material of said second phase.

The invention will be more clearly understood on reading the following description in conjunction with the drawings in which:

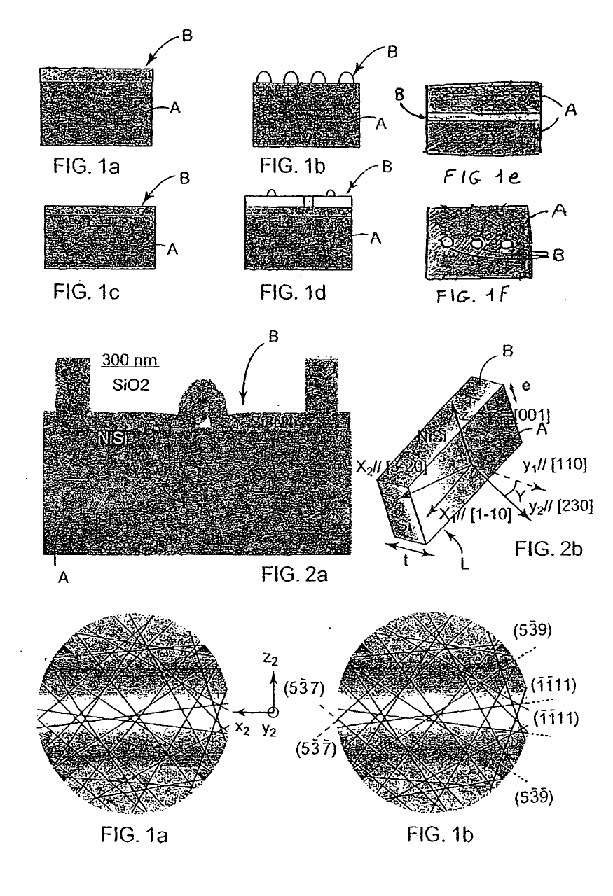

FIGS. 1a to 1f illustrate various configurations of the device to be studied: FIG. 1a, a single film; FIG. 1b, metallization bands or islands; FIG. 1c, a film with a zone included in the substrate; FIG. 1d, a transistor; FIG. 1e, a thin film inside a substrate; and FIG. 1f, fibers in a matrix. In general, A denotes the substrate or matrix and B denotes the microscale or nanoscale phase to be characterized;

FIGS. 2a and 2b show a sectional view of a transistor having a substrate made of silicon Si, which there is an NiSi film with a thickness e=20 nm and an Si₃N₄ film. A tungsten contact constitutes the drain contact D. The zone analyzed (FIG. 2b) is indicated by the arrow F. The thin lamella shown in FIG. 2b has a thickness t (which can be varied). The mean incident beam of electrons for the CBED patterns (direction z₀) is taken along the y₂ axis that makes an angle γ with the y₁ axis normal to the lamella. The directions and the corresponding crystallographic axes are illustrated in FIG. 2b. Note, CBED stands for Convergent Beam Electron Diffraction;

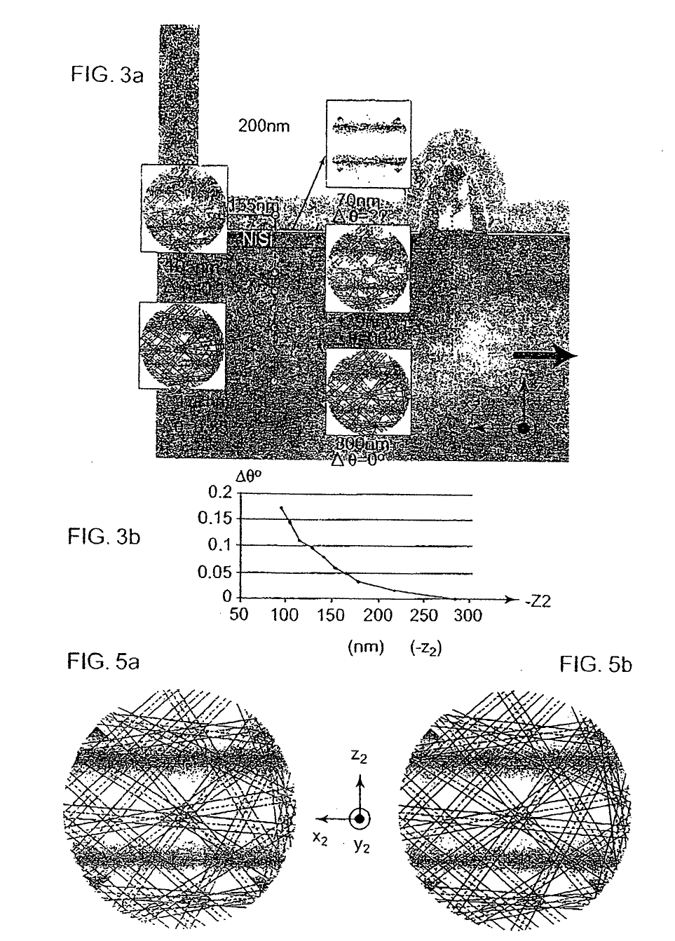

FIG. 3a is a montage of photographs illustrating five CBED diffraction patterns chosen from around fifty images actually claimed, along a straight line perpendicular to the surface (the −z₂ direction) at a distance of 155 nm from the drain contact D. For each pattern, the distance −z₂ (in nanometers) from the surface of the substrate (the interface with the thin film) and the measured angle Δθ are indicated, the curve in FIG. 3b showing the variation in the calculated angle Δθ as a function of −z₂;

FIG. 4a shows a CBED diffraction pattern taken along a [230] zone axis in unstrained silicon with a large depth z₂=300 nm (x₂//[3,−2,0], y₂//[2,3,0], z₂//[001];

FIG. 4b is the pattern 4a in which Holz lines positioned by the “JEMS” software have been adjusted. The position of these lines makes it possible to determine, accurately, the semiconvergence angle of the incident beam and the accelerating voltage (the method here is similar to that used in the “STREAM” project);

FIG. 5a is a CBED pattern along the [230] zone axis in deformed silicon (CBED pattern of the C type taken at the depth z₂=140 nm);

in FIG. 5b, lines obtained from three simulations with the “JEMS” software have been superimposed on this pattern:
the first system of lines represents the simulation of the diffraction pattern of a perfect silicon crystal tilted through by +θₘₐₓ relative to the x₂//[3-20] axis,
the second system of lines represents the simulation of the diffraction pattern of a perfect silicon crystal tilted through by −θₘₐₓ relative to the x₂//[3-20] axis, and
the third system of lines (dashed) represents the simulation of the diffraction pattern of the perfect silicon crystal but not tilted. The angle 2θₘₐₓ is denoted by Δθ;

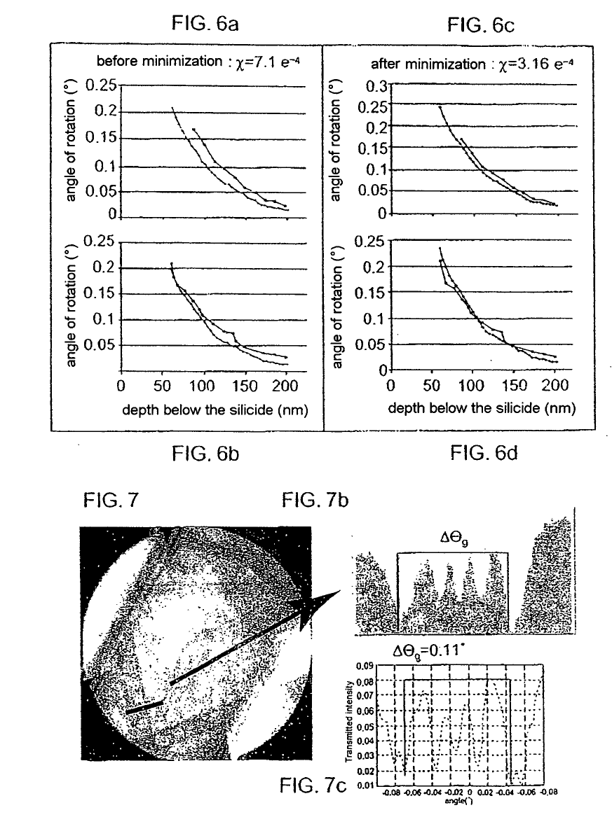

FIGS. 6a to 6d illustrate the feasibility of minimizing the elastic coefficients of the material. Three parameters have been minimized manually, by trial and error, namely the coherence temperature T₀ (an imaginary temperature at which the two materials would be coherent), the Young's modulus E and the Poisson's ratios ν. The squares represent the experimental measurements of the angle Δθ. The curves with many points are obtained from finite-element simulations and represent the angle 0.98Δβ, where Δθ=2βₘₐₓ. The minimization criterion χ determines the difference between the measured angles Δθ and the calculated angles 0.98Δβ, for various depths z₂ below this silicide and for different lamella thicknesses t;

FIG. 6a: lamella thickness t=300 nm, initial values of the parameters taken from the literature: T=410° C.; E=150 GPa; ν=0.1;

FIG. 6b: lamella thickness t=300 nm, initial values of the parameters taken from the literature: T₀=410° C.; E=150 GPA; ν=0.1;

FIG. 6c: lamella thickness t=320 nm, final values after partial manual minimization: T₀=430° C.; E=115 GPa; ν=0.288;

FIG. 6d: lamella thickness t=320 nm, final values after partial manual minimization: T₀=430° C.; E=115 GPa; ν=0.288;

FIG. 7a is a CBED diffraction pattern obtained for a lamella thickness t=320 nm at the distance −z₂=84 nm from the surface;

FIG. 7b is a profile obtained over the (5\overline{3}7) Holz band of FIG. 7a. The angular difference Δθ_{g} is marked by two vertical lines and represents the width of the Holz band;

FIG. 7c is a simulation of the profile of FIG. 7b, which shows that it is possible to reproduce the broadening of the Holz lines and the variations in intensity 1-A_{g}²(θ) in the Holz bands. This simulation used the results of the finite-element calculation, which is an illustration of point iv (optimized elastic constants and displacement R(y₁z₁)). Δθ_{g} is equal to 0.11°, which corresponds to rotation of the x₂ axis through an angle Δθ=0.14°. In the preliminary calculations, the widths Δθ_{g} of the x₂//[320] axis were ignored. A more refined minimization algorithm would seek to reproduce the curve similar to 7b in their entirety, with their oscillations and not to reproduce merely their width Δθ_{g} over the angle Δθ;

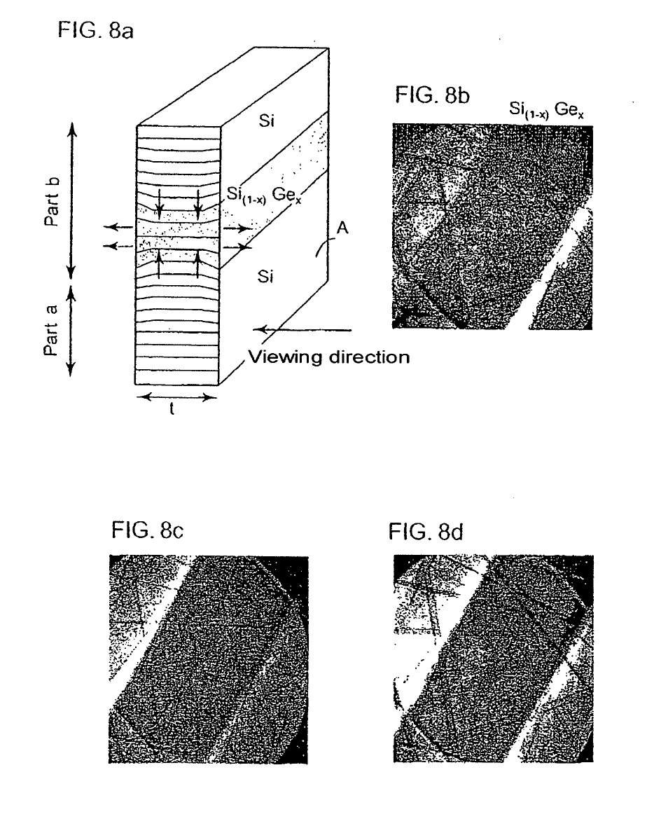

FIGS. 8a to 8d illustrate a second experimental example, in which the silicon substrate A is surmounted by an Si₍₁₋ₓ₎Geₓ film then by an Si film on the surface. FIG. 8a shows the thin lamella of thickness t. FIGS. 8b to 8d are CBED diffraction patterns in the [230] direction within the Si₍₁₋ₓ₎Geₓ film, in the Si substrate far from the deformed zone, and in the Si substrate close to the deformed zone, respectively; and

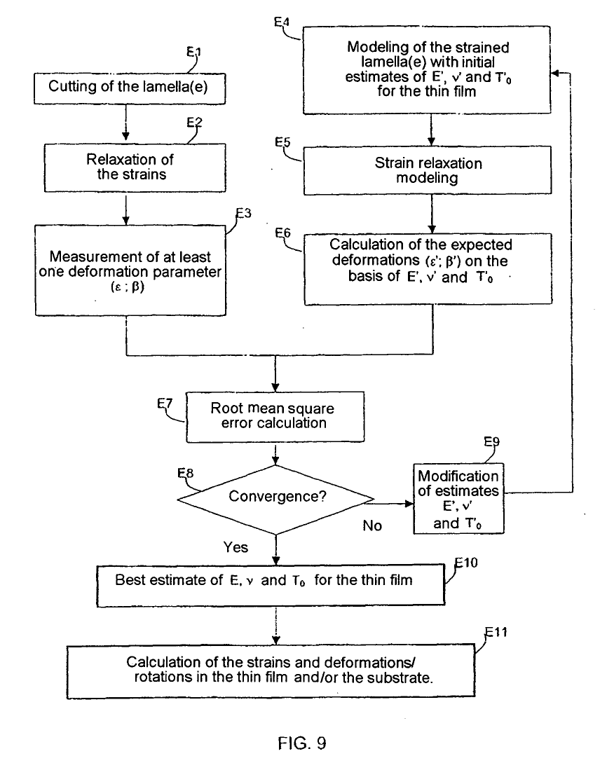

FIG. 9 shows a flow chart for one way of implementing the method of the invention.

The detailed description that follows relates to the particular case in which the phase to be characterized is a thin film, the specimens used are in the form of a thin lamella of different thicknesses, the deformation parameter in question is the rotation of the crystal axes in a plane perpendicular to the film, and the measurement technique adopted is CBED (convergent beam electron diffraction).

In this case, the method of the invention comprises:
a) the production of a lamella L with a sufficiently small thickness t and having two approximately parallel faces being approximately perpendicular to said substrate surface;
b) the measurement, on said lamella, of at least one deformation parameter of the substrate at the various depths from the surface; deformation parameter is also understood to mean rotation parameter of the substrate; and
c) the determination of at least one mechanical parameter of said film from at least said deformation/rotation parameter.

The method may include the production of several lamella(e) of different thicknesses and the implementation of step b) on each of said lamella(e). For at least one said lamella, step b) may be repeated at at least two different temperatures.

Advantageously, said measurement is carried out by generating, for points on the substrate located at different depths, CBED diffraction patterns for a convergent electron beam of axis Z₀ disoriented relative to the normal to said lamella, said patterns having Holz lines or bands. The determination at c) may then include the measurement of the width of the Holz lines of at least some of said patterns, for at least one crystallographic plane of the substrate. It is possible to calculate, from the width of these Holz lines, a maximum rotation βₘₐₓ along the electron beam axis for each pattern. This rotation is induced by the layer (or layers) placed on the substrate and said angle characterizes the properties thereof.

Next, a curve can be plotted that represents said rotation βₘₐₓ as a function of the depth at which said patterns were obtained. It is then possible to plot, by simulation, at least one curve representing this rotation as a function of the depth for possible values of the parameters to be extracted, for example Young's modulus and/or Poisson's ratio of the film to be analyzed in the case of an isotropic approximation and to minimize the difference between at least one simulated curve and a corresponding experimental curve, in order to determine these parameters. A similar technique may be used in the case of an isotropic modeling with parameters known to those skilled in the art. Values of the parameters that resulted in the simulated curve closest to the experimental curve are taken.

The aforementioned four points of the invention will be presented below.
point (i): the thin lamella of controlled geometry is extracted from or thinned in the device. A parallel-faced lamella is preferable but not absolutely essential. A slight angle may be present. A focused ion beam (FIB) was used, but alternative methods, that are conventional in specimen preparation for electron microscopy, may be used (mechanical thinning, cleavage, etc.), but the FIB technique has the advantages of being rapid, of not mechanically disturbing the system or device, and of fully controlling the operations.
point (ii): to measure the deformations, a convergent electron beam (CBED) is used for example in scanning mode. A nanoscale electron beam is focused onto various points of the specimen so as to completely map the deformations of the thin lamella (FIG. 3). A CBED diffraction pattern is therefore obtained at each point. This pattern comprises many Holz lines (more than 10 lines), each corresponding to a crystallographic plane indexed by a vector g of the reciprocal lattice. It is preferable to acquire the CBED patterns in the substrate (part A), since part B is generally too thin or too defective for being able to acquire good diffraction patterns in this zone b. However, for certain well-crystallized systems, patterns in zones a and b may be obtained. This would for example be the case if the layer a is a silicon layer and film b is composed of two thin films, namely an Si₁₋ₓGeₓ film (with a low Ge composition x, for example 10%) and an Si film.

For a given lamella thickness and a given temperature of observation, an entire series of CBED patterns is produced so as to determine the crystal parameters and rotations of the substrate.
point (iii): by varying the lamella thickness (the FIB technique allows this to be done easily) and the temperature of observation in the microscope, a whole series of experimental data points is obtained which make it possible (point iv) to calculate the elastic constants, the expansion coefficient of part B and the strains in the unthinned initial device. If part B is composed of a homogeneous film of a given material, it is unnecessary for the measurements to be carried out on the same lamella thinned in succession to different thicknesses. However, working on a single lamella the precision is increased, and this is essential if the system consists of a single nanosystem (for example a transistor). A single lamella thickness does not allow all the constants of the material to be correctly calculated. A single lamella thickness gives information only about the strains in the material (this is the case of the study of the curvature of semiconductor wafers via the Stoney formula). The strains are partly relaxed by a curvature of the substrate (see for example: “Measurement of elastic modulus, Poisson ratio, and coefficient of thermal expansion of on-wafer submicron films” by Jie-Hua Zhao, Todd Ryan, Paul S. Ho., Andrew J. McKerrow and Wei-Yan Shih, Journal of Applied Physics (1999), 85(9), 6421-6424).
point (iv): simulations using the theory of elasticity are then performed in order to reproduce the experimental results. In complex systems, only finite-element calculations may be carried out. In simpler systems (part B=thin film), an analytical formula may be implemented. The simulations reproduce the following phenomena:
   in the initial device, the various parts are strained or partially strained—the fact of extracting a thin lamella from the initial device relaxes the strains in the form of a rotation/change of crystal parameters and it is the observation and simulation of this strain relaxation that allows us to determine the parameters of part B.

The invention will be widely applicable in the surface treatment of mechanical parts, optimization of electronic circuits (metal contact, oxide film, etc.) or devices where the presence of two different materials necessarily creates mechanical strains.

The method according to the invention is novel although it does make use of techniques or physical effects that are well known:
the FIB (Focused Ion Beam) technique for specimen preparation;
the convergent beam technique (CBED: Conversion Beam Electron Diffraction), a particular technique used in electron microscopy. The STREAM project (see for example the publication “Software for Automation of TEM/CBED Methodology for strain determination”, IST-1999-10341 STREAM Consortium—Deliverable D23) uses a similar technique (FIB, convergent beam, simulation), but the technique essentially measures variations in the crystal parameters, whereas the method according to the invention is interested mainly in the local rotations of the crystal lattice. In addition, the aim of the STREAM project is not to measure elastic constants but to measure containted deformations strains in integrated circuits.

The STREAM project measured only changes in crystal parameters far from the two parts A and B of the device and neglected strain relaxation in the thin lamella. According to the invention, detecting the rotation of the crystal lattice makes the method more rapid and more precise, and allows the interface between parts A and B to be approached.

The power of the method according to the invention has been demonstrated by analyzing the strains produced by an NiSi film in an integrated circuit (specimen 1 in FIG. 2a). This system is relatively complex, as there are several electrical contacts and several materials present. For a rigorous treatment (which is quite possible), all the components of the system would have to be taken into account.

In a first analysis, it has been assumed that part B can be considered as a thin film of infinite lateral extent surmounted by the atmosphere (the layers situated above the NiSi film were experimentally removed, and the thickness of the thin film was measured to be equal to t=20 nm (see FIG. 2b).

The precise way in which the four points of part 3 are carried out will be described below.

To do this, it is necessary to define various geometric coordinate systems.

R₀=(x₀,y₀,z₀) denotes the geometric coordinate system tied to the microscope. The z₀ axis is parallel to the optical axis of the microscope, defined as being the mean direction along which the electrons propagate before the specimen. The images or the diffraction patterns are recorded in the (x₀,y₀) plane.

Various coordinate systems R_{c}=(x_{c},y_{c},z_{c}), R₁=(x₁,y₁,z₁) and R₂=(x₂,y₂,z₂), tied to the crystal structure of the silicon substrate (part A), are also defined, where:
x_{c}=[100], y_{c}=[010], z_{c}=[001]
x₁=1/\sqrt{2}[1\overline{1}0], y₁=1/\sqrt{2}[110], z₁=[001]
x₂=1/\sqrt{13}[3\overline{2}0], y₂=1/\sqrt{13}[230], z₂=[001]

The coordinate system R₂ is deduced from the coordinate system R₁ by a rotation of [001] axis through an angle γ=11.31° (see diagram 2b). The relationships between the microscope coordinate system and the crystal coordinate systems depends on the orientation of the specimen in the microscope.

Point (i): the thin lamella with practically parallel faces was produced with an FIB (see comments 1 and 2). The normal to the faces was chosen to be very close to the y₁ direction (FIG. 2b) (but here also a different geometry could be chosen, for example y₂). In the first series of experiments, the thickness t of the lamella was t=320 nm. This thickness was measured by a relatively conventional convergent beam technique—see the book “Electron MicroDiffraction” by J. C. H. Spence and J. M. Zuo (Plenum Publishing Corporation).

Comments: 1) the departure from parallelism was measured by the convergent beam and energy loss techniques. These techniques are relatively conventional (cf. the aforementioned book “Electron MicroDiffraction” by J. C. H. Spence and J. M. Zuo with regards to the convergent beam and the book “Energy-Filtering Transmission Electron Microscopy” by Reimer, published by Springer Verlag in the case of energy loss). The thickness of the lamella was therefore measured at various distances from the upper layer. It was found that the upper lamella made an angle of 1.15° to the lower lamella. In our feasibility demonstration, this angle was neglected and the lamella was considered to have parallel faces. However, it would have been possible to introduce this angle into the finite-element calculations.

2) The FIB is also capable of producing lamella with better parallelism.

Point (ii): The CBED patterns were taken along (or very close to) the orientation direction y₂=[230], that is to say y₂ was parallel to z₀. This is the direction used in the STREAM project (but other viewing directions are also possible. Forming CBED patterns in various directions would increase the number of experimental data points). Typically, the size of the electron beam was taken to be equal to 0.4 nm, the beam angle being around 15 mrad. During a scan, from 50 to 100 CBED patterns are taken every 4 nm in a direction perpendicular to the surface (the z₂ direction), starting from the surface, but only around ten patterns are used in the calculations. FIG. 3 indicates the position along the z₂ axis where five of these experimental patterns were obtained.

Various types of CBED pattern may be defined:
a) far from the interface between parts A and B, the silicon substrate is, with the measurement precision, considered as undeformed (for example, the −z₂=300 nm pattern in FIG. 3a). This may serve as a reference for determining the experimental parameters, as is done in the STREAM project;
b) by approaching the interface, the Holz lines remain fine, but start to shift slightly—the crystal parameters of the substrate undergo very slight modifications. This is the effect measured and quantified in the STREAM project;
c) closer to the interface, the Holz lines broaden (for example, the −z₂=139 nm pattern in FIG. 3a). We will call them Holz bands. This is the effect that is measured and quantified below; and
d) even closer to the interface, the Holz lines become too broad and too weak: the CBED patterns no longer contain enough details to be quantified (for example, the −z₂=70 nm pattern in FIG. 3a).

Point (iii):

Once this series of measurements has been carried out at the thickness t=320 nm, the lamella is thinned further down to a thickness t=300 nm. A second series of measurements is then carried out.

Fourteen patterns were chosen for the first thickness and ten for the second (see FIG. 5). This number is sufficient to reproduce the changes in the rotation.

Point (iv):

The JEMS software (P. Stadelmann, CIME-EPFL CH1015-LAUSANNE) was used to reproduce the position of the Holz lines of the CBED patterns far from the interface (type a CBED patterns), but other software packages or the theory presented in the aforementioned book by Spence and Zuo could be used. If these Holz lines of the silicon substrate—the reference crystal—are transferred onto the type-c CBED patterns, these lines lie in the middle of the Holz bands (the lamella is homogeneous and symmetrical). The positions of one of the ends of these Holz bands are simulated in the JEMS software by tilting the reference crystal by a rotation of x₂//[3-20] axis through an angle −θₘₐₓ (the lines in FIG. 5b). The positions of the second end are simulated in the JEMS software by tilting the reference crystal, by a rotation of x₂//[3-20] axis through an angle θₘₐₓ (the lines in FIG. 5b). A rotation of angle Δθ=2θₘₐₓ therefore allows the variable widths Δθ_{g} of the Holz bands to be reproduced to a good approximation.

Before the thinning operation by the FIB technique, the silicon substrate is strained, but generally only slightly deformed. After thinning, the strains produced by the interface between parts A and B are relaxed. At each coordinate point (y₁,z₁), the finite elements therefore give a displacement R(y₁,z₁) of components u and v along the y₁ and z₁ axes. This displacement may be decomposed into a local translation, a pure deformation ε(y₁,z₁) and a local rotation of x₁ axis and through an angle β(y₁, z₁):

$$β ( {y}_{1} , {z}_{1} ) = \frac{1}{2} ( \frac{\partial v}{\partial {y}_{1}} - \frac{\partial u}{\partial {z}_{1}} ) .$$

The simulations in the JEMS software indicate that it is these local rotations β(y₁,z₁) along the electron beam (the z₀ direction) that are the main cause of the broadening of the Holz lines into Holz bands. A rotation of x₁ axis and through an angle β(y₁,z₁) may be decomposed into three rotations of x₂ axis through an angle θ(y₁,z₁), of the y₂ axis through an angle θ′(y₁,z₁) and of the z₂ axis through an angle θ″(y₁,z₁). To a first order, only the first of these three rotations is important, giving the equation:
θ(y₁,z₁)=0.98β(y₁,z₁).

In particular, it has also been shown that the angle θₘₐₓ is to a first order equal to 0.98βₘₐₓ, where βₘₐₓ is the maximum value of the angle β(y₁,z₁) along the electron beam, that is to say along y₂, or, which amounts to the same thing, to the maximum value of the angle β(y₁,z₁) along the y₁ direction since our lamella is periodic in x₁:
θₘₐₓ(z₁)=0.98βₘₐₓ(z₁)=0.98Max(β(y₁,z₁)).

In this feasibility demonstration, this approximate property is used to optimize the constants of the material. Each CBED pattern taken at a depth z₂ is therefore characterized by a single parameter Δθ(z₂)=2θₘₐₓ(z₂) (FIG. 3b).

The curves shown in FIG. 6 plot the experimentally measured Δθ values and the 0.98Δβ values (where Δβ=2βₘₐₓ) determined from the finite-element calculations.

The calculated curves in FIGS. 6a and 6b use parameters for the NiSi material taken from the literature. To reproduce the experimental curves better, the parameters of the NiSi material are varied in the calculation of the calculated curves shown in FIGS. 6c and 6d. By trial and error, the constants for the NiSi layer (Young's modulus E and Poisson's ratio ν) are obtained (using the isotropic approximation).

A few details will now be given about the use of finite elements. A commercial software was used and the plane deformation approximation was used.

Three particular states are important:
state 1: it is assumed that there exists a temperature T₀=T₁+ΔT at which the silicon substrate and the NiSi film would be coherent and unstrained (this temperature is not necessarily obtainable—it could be referred to as the “imaginary coherence temperature”);
state 2: the thin lamella of thickness t, coherent at temperature T₀, is cooled to the experimental temperature T₁=T₀−ΔT. The strains are partly relaxed at the surface of the thin lamella.

The classical laws of solid mechanics were used to determine the displacements R(y₁,z₁). In particular, the equation between the stresses and strains is given by:

$$( \begin{matrix}{σ}_{{y}_{1} {y}_{1}} \\ {σ}_{{z}_{1} {z}_{1}} \\ {σ}_{{y}_{1} {z}_{1}}\end{matrix} ) = \frac{E}{( 1 + v ) ( 1 - 2 v )} ( \begin{matrix}1 - v & v & 0 \\ v & 1 - v & 0 \\ 0 & 0 & 1 - 2 v\end{matrix} ) ( \begin{matrix}{ɛ}_{{y}_{1} {y}_{1}} \\ {ɛ}_{{z}_{1} {z}_{1}} \\ {ɛ}_{{y}_{1} {z}_{1}}\end{matrix} ) - \frac{E}{( 1 - 2 v )} ( \begin{matrix}α \\ α \\ 0\end{matrix} ) Δ T$$

where ΔT=T₀−T₁, E is the Young's modulus, ν is the Poisson's ratio, and α is the thermal expansion coefficient. These equations apply in the Si substrate (E_{A}=156 GPa, ν_{A}=0.277 and α_{A}=2.6×10⁻⁶ K⁻¹) and in the thin NiSi film (E_{B}, ν_{B}, α_{B} and ΔT were optimized by minimizing the distance χ between the experimental and calculated curves (see FIG. 6)) using the assumption of plane strain. The strains were calculated in the plane defined by the direction of the incident electrons, y₁//z₀ and the z₁ axis; and
State 3: before extraction of the lamella, the system was much more strained as the strains are not relaxed via the surfaces. Once the parameters (for example the elastic coefficient and the thermal expansion coefficient) have been determined, the strains in the integrated circuit before thinning can be determined by means of the present method. The strains in the transistor are calculated using the optimized constants: these are the strains taken in the middle of a lamella of very large thickness t₀ or those of a periodic lamella of infinite thickness.

Comments:

R₁) as regards point (iv), in this feasibility demonstration, the elastic constants are adjusted manually, although automatic optimization is possible.

R₂) as regards point (iv), we also used the approximate equation: θₘₐₓ=0.98βₘₐₓ, that is to say only the total width Δθ_{g} of the Holz bands was taken into account. A very accurate but longer adjustment would consist in reproducing the Holz bands in their entirety. Each CBED pattern would then no longer be characterized by a single value Δθ, but by a set of profiles identical to those shown in FIG. 7b.

These profiles represent in fact the function 1-A_{g}²(s) where A_{g}(s) is the amplitude of the wave function diffracted by the planes of index g, and s measures the deviation from Bragg's law for these planes g. As explained in the aforementioned book by Spence and Zuo, s and θ are connected via a simple formula and various approximations may be made in order to calculate A_{g}(s). It has been shown, for the fine Holz lines of CBED patterns taken in the y₂//[230] direction, a two-wave approximation or a kinematic approximation gives the same physical result. In the kinematic approximation:

$${A}_{g} ( s , {z}_{2} ) = \frac{ⅈπ}{{ξ}_{g}} {\int }_{0}^{i} exp ( - 2 πⅈ gR ( {y}_{2} , {z}_{2} ) exp ( - 2 πⅈ {sy}_{2} ) ⅆ {y}_{2}$$

The parameter to be minimized would in this case be the sum of the distances between curves of the type shown in FIGS. 7b and 7c. The advantage of the above formula is that not only the rotations but also the pure deformations are taken into account in the R(y₂,z₂) term (even if it has been shown that the essential effect in the broadening of the Holz bands is that due to the local rotations).

R₃) points (i) and (ii) have also been made on specimen 2 described in part 3.

R₄) at different temperatures, the principle of the method remains similar, and is relatively conventional in the measurement of strains. Introducing measurements at different temperatures amounts to increasing the number of experimental data points and the number of parameters to be optimized: the methodology is quite similar.

The flowchart shown in FIG. 9 gives a summarizing view of the way in which the method of the invention that has just been described in detail is implemented.

Step E1 of the method is the cutting of at least one lamella comprising part of the substrate and part of the film placed on its surface. This results in a relaxation of the strains (E2) and therefore a deformation of said lamella. At step E3, at least one deformation parameter (preferably a rotation β) is measured corresponding to a plurality of points on the lamella, at various depths from the film/substrate interface.

Independently of steps E1-E3, modeling, typically by finite-element analysis, of the strained lamella, that is to say before it is cut, is carried out. To do this, a first estimate of the mechanical properties of the thin film, such as its Young's modulus E′, its Poisson's ratio ν′ and its coherence temperature T′₀, is made (step E4). Next, at step E5 the relaxation of the strains is modeled. This may be carried out by replacing imposed (zero) displacement boundary conditions with free boundary conditions. At step E6, the expected values ε′ and β′ of the deformation parameter or parameters corresponding to the points where the measurements of step E3 were taken are determined on the basis of this simulation.

Preferably, but not necessarily, steps E1-E6 are repeated for a plurality of lamella of different thicknesses, or more generally lamella having a different geometry, and/or at different temperatures.

The root mean square error between the measured and expected values is calculated (E7) and minimized by varying the estimates of the mechanical properties of the thin film (E9) and iteration of steps E4-E7, until convergence is reached (E8).

In this way, an optimum estimate, within the root mean square error, of the mechanical properties of said film is obtained (E10).

Optionally, the information thus obtained is used, in step E11, to calculate a deformation and/or strain state of the thin film and/or of the substrate.

The above description has been essentially limited to the case of a substrate on which a thin film has been deposited and to measurements made on specimens formed by a lamella having approximately mutually parallel faces perpendicular to the interface between the substrate and the film. However, the method also applies to specimens having a different shape, for example a wedge shape. What is important is that the geometry of this specimen be accurately known, in order to be able to carry out the modeling, and that it allows strain relaxation.

Likewise, when measurements are carried out on a plurality of specimens in order to obtain a better estimate of the mechanical properties of the film, the mechanical property of said specimens be varied, and not just their thickness. For example, it is possible to use a series of wedge-shaped specimens having different angles between their faces and/or a different angle of inclination relative to the film/substrate interface.

As the characterization of a surface layer was of particular interest, the various measurements of deformation parameters were made at different depths from the film/substrate interface. More generally, in the case of inclusions, fibers or filaments, the term “depth” no longer applies but simply the distance from the interface between the two phases in question. Furthermore, certain of the measurement points may, at least in some cases, lie within the nanoscale or microscale phase to be characterized.

As regards the measurement technique, methods other than CBED may be used, such as for example LACBED (Large-Angle Convergent Beam Electron Diffraction).

In the example in question, the only deformation parameter considered was the angle of rotation β, determined by measuring the broadening Δθ of the Holz lines. The displacement of the Holz lines, associated with pure deformations, could also be taken into account. More generally, the method of the invention may include the use of one or more deformation parameters determined from various directly measured quantities.

1. A method for determining at least one mechanical parameter of at least one material in a composite system comprising at least two distinct phases (A, B), comprising:
(a) producing at least one specimen (L) comprising a first part of a first phase (A) and a second part of a second phase (B), the second part consisting of the material to be characterized, the specimen (L) having at least one dimension (t) small enough to allow the strains in said specimen to be relaxed;
(b) measuring on said specimen (L), at least one deformation parameter (β) of at least said first phase (A), in correspondence with a plurality of points lying at different distances from an interface between said first (A) and second (B) phases; and
(c) determining from at least said deformation parameter (β) at least one mechanical parameter of said second phase.

2. The method as claimed in claim 1, which comprises:
(i) producing a plurality of specimens (L) that differ from one another in respect of at least one geometrical property;
(ii) implementing step b) on each of said specimens (L); and
(iii) using step c) the measurements made on said plurality of specimens.

3. The method as claimed in claim 1, in which, for at least one specimen (L), step b) is repeated at at least two different temperatures.

4. The method as claimed in claim 1, in which step c) comprises:
(i) modeling the strain relaxation in said specimen (L) using a first estimate of at least one mechanical property of the material of said second phase (B);
(ii) comparing the measurement results of step b) with those of said modeling; and
(iii) modifying said estimate of at least one mechanical property of the material of said second phase and the reiteration of substeps i) to iii) until the difference between said measurement results and the modeling results is minimized.

5. The method as claimed in claim 4, in which the modeling is a finite-element numerical simulation.

6. The method as claimed in claim 1, in which said composite system is chosen from among: a substrate having a continuous layer on its surface; a substrate having metallization bands or islands on its surface; a layer with a zone included in the substrate; a transistor; a layer on the inside of a substrate; a matrix containing inclusions; fibers or filaments.

7. The method as claimed in claim 1, in which said specimen (L) has at least one microscale or nanoscale dimension (t).

8. The method as claimed in claim 1, in which said specimen (L) is a lamella having two approximately parallel faces lying approximately perpendicular to the interface between said first (A) and second (B) phases.

9. The method as claimed in claim 2, which comprises the production of a plurality of lamellae (L) of different thicknesses.

10. The method as claimed in claim 1, in which said specimen is a lamella placed at an angle to the interface between said first (A) and second (B) phases.

11. The method as claimed in claim 2, which comprises the production of a plurality of lamellae placed at different angles to the interface between said first (A) and second (B) phases.

12. The method as claimed in claim 1, in which said specimen is a wedge-shaped lamella having two faces making an angle between them.

13. The method as claimed in claim 12, which comprises the production of a plurality of lamella(e) having two faces making different angles between them.

14. The method as claimed in claim 1, in which the measurements provided in step b) are carried out by diffraction of a convergent electron beam.

15. The method as claimed in claim 14, in which step b) includes the observation of Holz lines for at least one crystallographic plane of said first phase (A) and the determination of at least one parameter from among: the width of said Holz lines, their position and their internal structure.

16. The method as claimed in claim 15, in which step b) comprises the determination of at least the width of at least some of said Holz lines and the calculation, for each of them, of a maximum rotation βₘₐₓ along the axis of the electron beam.

17. The method as claimed in claim 16, in which step c) involves the plotting of at least one curve representing a said maximum rotation as a function of the distance relative to the interface between said first (A) and second (B) phases.

18. The method as claimed in claim 17, in which step c) also involves, by simulation, the plotting of curves representing the maximum rotation βₘₐₓ as a function of the distance relative to the interface between said first (A) and second (B) phases for possible values of Young's modulus and/or Poisson's ratio of the material of said second phase (B), and also the minimization of the difference between the simulated curves and the experimental curves in order to determine the Young's modulus and/or the Poisson's ratio of the material of said second phase (B).
